(19) United States
(12) Patent Application Publication
(10) Pub. No.: US 2018/0039925 A1
(43) Pub. Date: Feb. 8, 2018

(54) CRITICAL INVENTORY REPORTING TOOL

(71) Applicant: Wal-Mart Stores, Inc., Bentonville, AR (US)

(72) Inventors: Willie Montgomery, III, Rogers (US); Venkataraja Nellore, Bentonville, AR (US)

(21) Appl. No.: 15/646,895

(22) Filed: Jul. 11, 2017

Related U.S. Application Data
(60) Provisional application No. 62/372,294, filed on Aug. 8, 2016.

(51) Int. Cl. G06Q 10/06; G06Q 10/08

(52) U.S. Cl. CPC G06Q 10/06315; G06Q 10/0875; G06K 19/06028

(57) ABSTRACT

Examples of the disclosure provide a system and method for entity-specific inventory optimization. An inventory optimization module obtains inventory data for an individual entity at a given time, including variance date codes associated with an individual item, and identifies at least one item of a plurality of items that exceeds an inventory threshold based on the inventory data. An elasticity estimation module receives the identified item from the inventory optimization module, identifies a value response curve for the identified at least one item based at least in part on entity-cluster data, generates an entity-specific elasticity value for the item, and generates an inventory optimization recommendation based on the generated entity-specific elasticity value and the variance date codes of the inventory data.

### BACKGROUND

Inventory management is a complex process for many environments, involving demand patterns, lead time, shelf capacity, back room capability, item type, and so forth. In some instances, an inventory environment may receive more product than they can move within regular transaction patterns, which can lead to waste, as well as negatively affect physical inventory space, labor, and profits.

### SUMMARY

Examples of the disclosure provide a system and method for entity-specific inventory optimization. An inventory optimization module obtains inventory data for an individual entity at a given time, including variance date codes associated with an individual item, and identifies at least one item of a plurality of items that exceeds an inventory threshold based on the inventory data. An elasticity estimation module receives the identified item from the inventory optimization module, identifies a value response curve for the identified at least one item based at least in part on entity-cluster data, generates an entity-specific elasticity value for the item, and generates an inventory optimization recommendation based on the generated entity-specific elasticity value and the variance date codes of the inventory data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for entity-specific inventory optimization.

FIG. 2 is an exemplary block diagram illustrating an optimization environment for entity-specific inventory optimization recommendations.

FIG. 3 is an exemplary flow diagram illustrating network communication within an optimization environment for entity-specific inventory optimization.

FIG. 4 is an exemplary flow chart illustrating operation of the computing device to generate an entity-specific inventory optimization recommendation.

FIG. 5 is an exemplary flow chart illustrating operation of the computing device to generate adjustments across an entity cluster.

FIG. 6 is an exemplary diagram illustrating a critical inventory report.

FIG. 7 is an exemplary diagram illustrating an optimization environment operating as a cloud-based service.

FIG. 8 is an exemplary block diagram illustrating an operating environment for a computing device implementing an optimization environment.

Corresponding reference characters indicate corresponding parts throughout the drawings.

### DETAILED DESCRIPTION

Referring to the figures, examples of the disclosure enable entity-specific inventory optimization for items at an individual entity level. As used herein, an entity may refer to a business entity, such as a retail business for example, and examples are provided that may describe a retail business environment. However, aspects of the disclosure are not limited to a retail or business environment. Elasticity estimation generally focuses on supply and demand for a specific product in the marketplace. Elasticity refers to the relationship or correlation between demand and valuation associated with an item, object, or service, for example. Inventory optimization refers to managing inventory items for optimal revenue and mitigation of loss or throw away. Optimal, as used herein, may refer to the greatest or substantially greatest revenue associated with inventory items correlated with the least or substantially least volume of waste, loss, or throw away, in order to mitigate waste and loss of revenue. Aspects of the disclosure provide for entity-cluster-specific elasticity estimation at the item-entity level in order to recommend optimal valuation and/or forecast adjustments for an individual item type at an individual entity, or across a cluster of stores, or both. As used herein, value may refer to a cost or price associated with an item offered for sale, and valuation adjustment may refer to pricing adjustment, for example. Because the valuation adjustment recommendation is for a specific item and relative to a specific entity or store, and because the recommendation is directed towards inventory optimization opportunities, such as adjusting a value, featuring the item, or adjusting inventory replenishment values for the item, the entity-specific inventory optimization recommendations are dynamically tailored for each item and store. As used herein, an individual entity may refer to a specific, physical location, such as a physical store location, with each individual entity representing a separate, physical store location within a possible chain of stores, for example.

Aspects of the disclosure further enable increased user interaction performance and user efficiency via user interface interaction because thresholds and entity-specific factors in combination with dynamic data are used to dynamically update inventory data and generate inventory-related adjustments based on user interface interaction via network communications. Automatic alerts, notification, and/or recommendations may be generated as new data is obtained over the network from the inventory environments, which also contributes to increased user efficiency and reduced error rates, as well as faster processing.

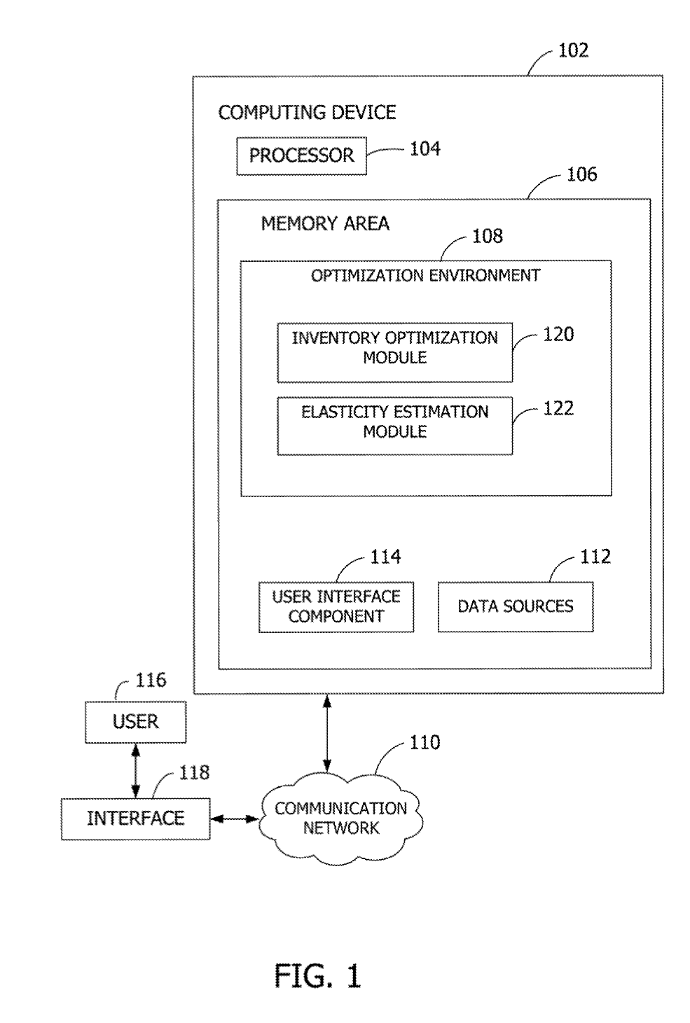

Referring again to FIG. 1, an exemplary block diagram illustrates a computing device for entity-specific inventory optimization. In the example of FIG. 1, the computing device 102 represents a system for inventory data analysis and entity-cluster elasticity estimation for generating entity-specific inventory optimization recommendations for specific items. As used herein, items refer to products or resources that may be bought and sold, or otherwise part of a value transaction.

The computing device represents any device executing instructions (e.g., as application programs, operating system functionality, or both) to implement the operations and functionality as described herein. The computing device may include a mobile computing device or any other portable device. In some examples, the mobile computing device includes a mobile telephone, laptop, tablet, computing pad, netbook, gaming device, and/or portable media player. The computing device may also include less portable devices such as desktop personal computers, kiosks, tabletop devices, industrial control devices, wireless charging stations, and electric automobile charging stations. Additionally, the computing device may represent a group of processing units or other computing devices.

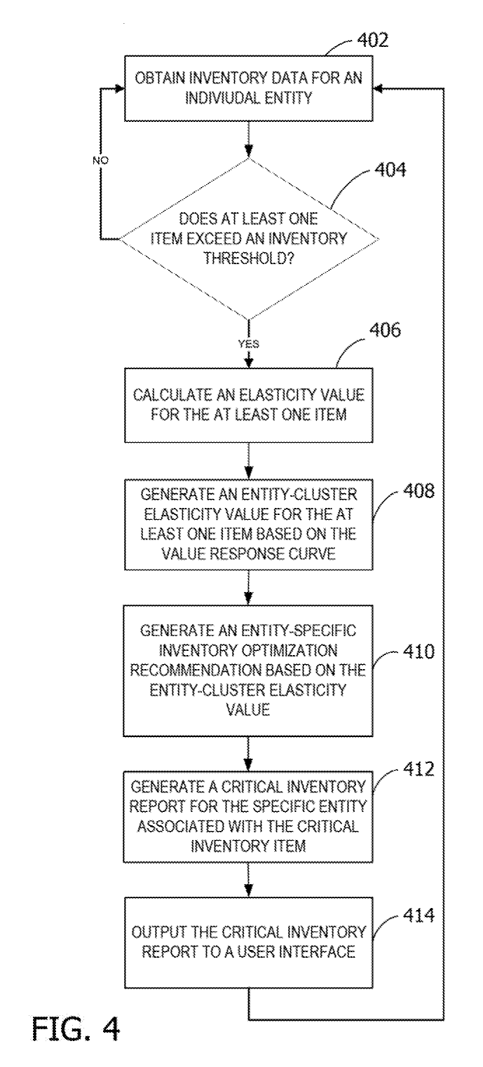

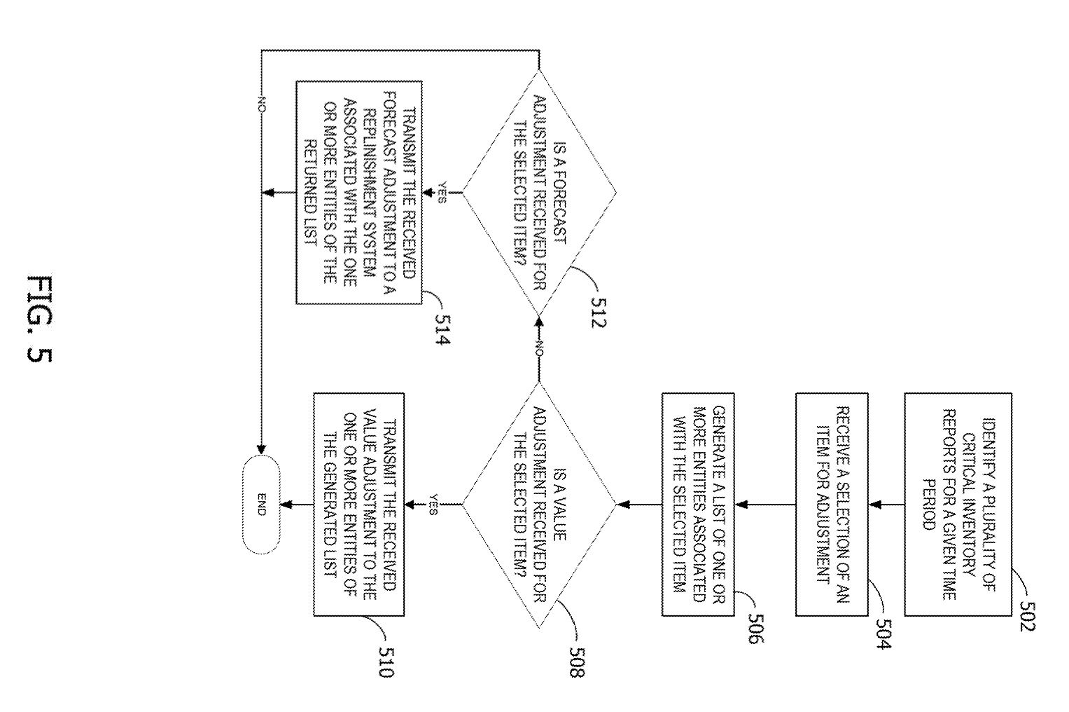

In some examples, the computing device has at least one processor 104, a memory area 106, and at least one user interface. The processor includes any quantity of processing units, and is programmed to execute computer-executable instructions for implementing aspects of the disclosure. The instructions may be performed by the processor or by multiple processors within the computing device, or performed by a processor external to the computing device. In some examples, the processor is programmed to execute instructions such as those illustrated in the figures (e.g., FIG. 4 and FIG. 5).

In some examples, the processor represents an implementation of analog techniques to perform the operations described herein. For example, the operations may be performed by an analog computing device and/or a digital computing device.

The computing device further has one or more computer readable media such as the memory area. The memory area includes any quantity of media associated with or accessible by the computing device. The memory area may be internal to the computing device (as shown in FIG. 1), external to the computing device (not shown), or both (not shown). In some examples, the memory area includes read-only memory and/or memory wired into an analog computing device.

The memory area stores, among other data, one or more applications. The applications, when executed by the processor, operate to perform functionality on the computing device. Exemplary applications include optimization environment 108, which may represent an application for entity-specific processing of inventory data for generating elasticity estimations and inventory optimization recommendations. The applications may communicate with counterpart applications or services such as web services accessible via communication network 110. For example, the applications may represent downloaded client-side applications that correspond to server-side services executing in a cloud. The memory area may store data sources 112, which may represent data stored locally at memory 106, data access points stored locally at memory area 106 and associated with data stored remote from computing device 102, or any combination of local and remote data.

The memory area further stores one or more computer-executable components. Exemplary components include a user interface component. The user interface component 114, when executed by the processor 104 of computing device 102, cause the processor 104 to perform operations, including to receive user selections, such as data requests, during user interaction with optimization environment 108, for example.

In some examples, the user interface component includes a graphics card for displaying data to the user and receiving data from the user. The user interface component may also include computer-executable instructions (e.g., a driver) for operating the graphics card. Further, the user interface component may include a display (e.g., a touch screen display or natural user interface) and/or computer-executable instructions (e.g., a driver) for operating the display. The user interface component may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way. In another example, the user may input commands or manipulate data by providing a gesture detectable by the user interface component, such as a touch or tap of a touch screen display or natural user interface.

In some examples, a user 116 may interact with the system of computing device 102 via communications network 110 using interface 118. Interface 118 may be a user interface component of another computing device communicatively coupled to communication network 110, for example. In some examples, interface 118 may provide an instance of optimization environment 108 for receiving user input and displaying content to the user, while elasticity estimation and inventory optimization recommendation operations are performed on the backend at computing device 102.

Optimization environment 108 provides components for entity-specific inventory data processing to generate inventory optimization recommendations for a specific item at a specific entity, as well as inventory adjustment measures for a specific item across a cluster of specific entities. In some examples, optimization environment 108 includes inventory optimization module 120 and elasticity estimation module 122.

Inventory optimization module 120 is a component of optimization environment 108 that obtains inventory data for individual items associated with individual entities, identifies one or more items that exceed an inventory threshold based on variance date codes associated with the items, and generates an inventory optimization recommendation using an entity-specific elasticity value provided by elasticity estimation module 122 for output to the individual entity. Variance date codes may refer to a recommended shelf life associated with a specific item or item type. For example, a variance date code for one item type may be four days, while a variance date code for another item or item type may be twenty-two days.

Entity-specific factors, specific factors associated with an individual entity that affect or otherwise impact the inventory data for a specific item relative to that specific entity, may be used by elasticity estimation module 122 to generate the entity-specific elasticity value for an item exceeding an inventory threshold. For example, entity-specific factors may include, without limitation, entity format, entity size, entity region, volume of sales, entity location, or entity inventory.

Entity format may refer to a variable type of entity within a larger entity environment, such as a type of branded store within the branded environment. For example, a company may have variable formats or types of stores within the company of stores, such as a small neighborhood store format, a large megastore format, an urban format, a rural format, a domestic format, an international format, and so forth. The format of the entity may have an impact on the data related to an item sold or otherwise offered for sale at that specific entity.

Likewise, entity size may be another entity-specific factor that impacts the data related to an item associated with that specific entity. As used herein, entity size may refer to an available square footage of retail space for that entity location, rather than a format of the entity. Entity region may refer to the geo-physical location of a specific entity. As used herein, entity location may refer to a type of environment associated with the geo-physical location of a specific entity, such as, without limitation, rural environment, urban environment, residential environment, coastal environment, land-locked environment, and the like.

Entity inventory refers to information on other items, products, or services provided by or offered at the specific entity, which may impact data related to the specific item that is the subject of the data request. These entity-specific factors may be used to normalize the item-entity data, for example, by taking into account where a store is located, what size or type of store it is, and normalizing sales data related to the item based on that information. In other words, normalizing the item-entity data is not directed at modifying the structure of the data, but rather adjusting values of the data using variable weights of the various entity-specific factors.

Elasticity estimation module 122 is a component of optimization environment 108 that receives the item-entity data, identifies an entity cluster to use in generating an elasticity value for the item, and generates an entity-specific elasticity measure for the item based at least in part on the entity cluster data. Elasticity estimation module 122 may identify a value response curve, using the best fit curve, or best fit value response curve, by running a number of models against normalized item-entity data, using a number of data points from the normalized data and a R̂2 value (statistical measure of curve fitness) to determine which model is the best fit for providing the elasticity estimation measure.

Inventory optimization module 120 receives the entity-specific elasticity measure from elasticity estimation module 122, and uses that measure to calculate an inventory optimization recommendation for the item specific to the associated individual entity. In other words, the generated inventory optimization recommendation is specific to that item and the inventory levels of that item at that entity, or is an item-entity specific recommendation. The inventory levels for an individual entity may include days on shelf (DOS) information, which refers to how many days of inventory is at the entity for a particular item. Inventory optimization module 120 evaluates inventory levels or a specific item for an individual entity to determine if the DOS is less than or greater than the variance date code, when analyzing whether or not to generate an inventory optimization recommendation. For example, where the DOS is less than the variance date codes, no action may be taken, but where the DOS is more than the variance date codes, a recommendation may be generated in order to reduce inventory levels to a predetermined threshold. The predetermined threshold may be a minimum of two weeks on shelf (WOS) or may be the variance date code itself, in some examples.

The inventory optimization recommendation may provide one or more inventory opportunities associated with the item, such as a value adjustment recommendation, a feature item recommendation, an inventory adjustment recommendation, or a no action recommendation. A value adjustment recommendation may be a specific value that represents a value reduction for the inventory of that item, for example. A feature item recommendation may be an opportunity to feature or otherwise promote the item, such as in a weekly transactional promotion or by physically locating the inventory of that item at a high traffic area of the specific entity, for example. An inventory adjustment recommendation may be a specific inventory replenishment value that represents a reduction in a future replenishment order, for example. A no action recommendation may highlight potential inventory risks but indicate that the calculated risk is within a predetermined threshold, and no action is recommended for that particular item at the time for the given entity. In this way, inventory optimization module 120 may recommend an adjustment of the total inventory of an item or item type for the individual entity in order to reduce the total inventory level of that item to a desirable or manageable range for optimal revenue and mitigation of loss.

In an illustrative example of a value adjustment recommendation, an optimal markdown value for an item or item type may be calculated by inventory optimization module 120 based on any combination of total inventory, DOS, elasticity, valuation rules, and variance date codes. However, a value adjustment recommendation will not exceed the cost of the item in these examples. In addition, the value adjustment recommendation may be accompanied by a throw risk value, which is a value that indicates the potential monetary value that may be lost if no action is taken based on the recommendation. This provides for a more informed decision before action is taken on the inventory optimization recommendations.

As described herein, the optimization environment 108 provides a system that determines the behavior of value change on transaction volume at an entity-cluster level by using historical item value data, historical volume transaction data, and information specific to that item and store, such as promotions, time period of sales, seasonality, similar items sales data, market value inflation, and wage inflation, which may be stochastic due to variation in demand by day. Aspects of this disclosure enable estimation of an optimal value point for revenue related to a specific item at a specific entity. By determining the elasticity of an item at a cluster of entities, aspects of the disclosure then use that elasticity in conjunction with inventor data to provide optimal value recommendations or inventory optimization recommendations directed at increasing revenue and decreasing waste or loss associated with an item.

Different stores or entities in different locations may have different valuations on the same item, which may be driven by elasticity in some examples, which itself is driven by how sensitive a customer base associated with that store is to a change in value and how such a change in value affects sales of the item at that specific location. In addition to value, other factors may impact item sales, such as inflation, seasonality, and so forth. By identifying elasticity of an item at an item-store level, recognizing that each item at each store may have a different value of elasticity, using entity-specific factors, an optimal valuation recommendation is provided at an item-entity level as part of the inventory optimization recommendation. Additionally, by processing the elasticity associated with an item in conjunction with inventory data of a specific entity, including current inventory data and historical inventory data, the inventory optimization recommendation is tailored to a specific entity.

In some examples, inventory optimization recommendations, or critical inventory reporting, may identify items in fresh departments that are nearing the end of shelf life. As used herein, critical inventory refers to inventory that has an associated shelf life or variance date code. Using historical demand and transaction values, the item's sensitivity to value changes may be estimated. Using shelf life, demand patterns, and current inventory data, excess inventory that may not be sold before the item expires or reaches end of shelf life is calculated. Entities are then recommended to reduce the transaction value associated with the item, based on elasticity and a measure of excess inventory, in order to move the excess inventory before the item expires or reaches end of shelf life. Although aspects of this disclosure have been described with respect to critical inventory, aspects of this disclosure may also be applied towards non-critical inventory, or inventory without associated shelf life or variance date codes, in order to manage inventory volume and/or throughput, for example.

An inventory optimization recommendation may offer an opportunity to reduce a value associated with an item, providing a specific value amount to associated with the item as a markdown in order to move the item inventory. This markdown may be a temporary reduction directed towards minimizing inventory of the item to reduce the probability of the item being thrown away, for example. In the example scenario of fresh items, the optimization environment enables an entity to quickly identify and reduce items associated with a throw risk, reducing waste and increasing revenue for the entity. In some examples, an entity environment may include multiple entities, such as a chain of stores, governed by a home office. In this example, a home office may have an opportunity to review multiple critical inventory reports across a cluster of stores to identify items that may benefit from markdowns across the company, or from company-wide inventory adjustments.

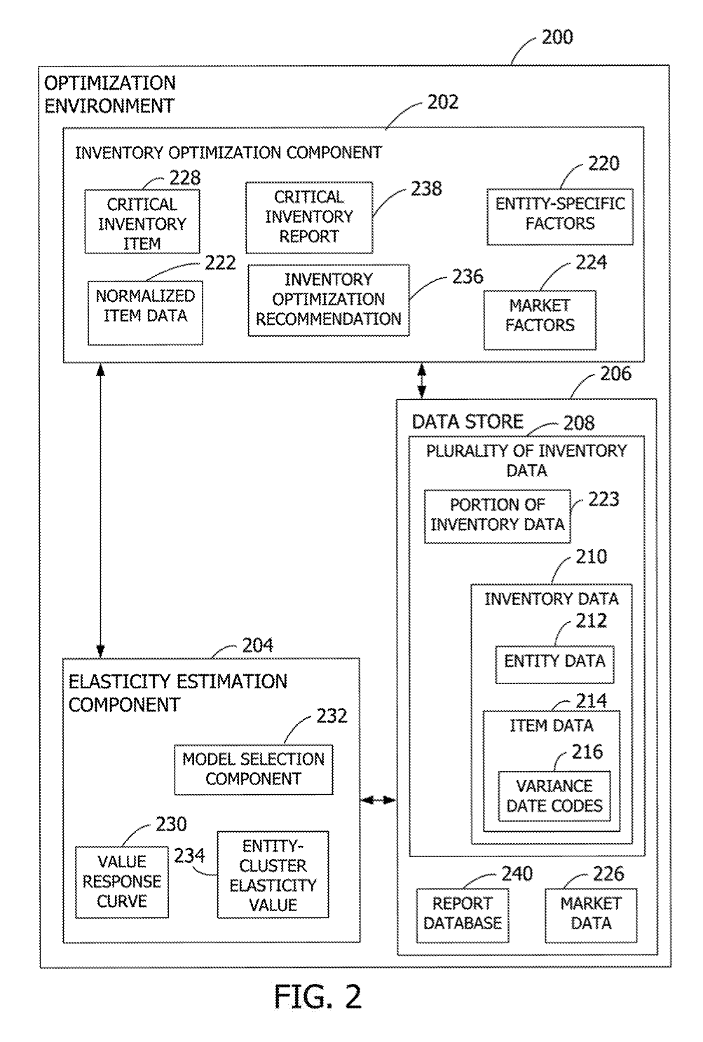

FIG. 2 is an exemplary block diagram illustrating an optimization environment for entity-cluster elasticity estimations and entity-specific inventory optimization recommendations. Optimization environment 200 is an illustrative example of one implementation of optimization environment 108 in FIG. 1. Optimization environment 200 includes inventory optimization component 202, elasticity estimation component 204, and data store 206.

Inventory optimization component 202 processes inventory data to identify critical inventory items associated with specific entities. Inventory data may be obtained from, or received from, data store 206, for example. Data store 206 may maintain plurality of inventory data 208 associated with a plurality of entities. Inventory optimization component 202 may process inventory data dynamically, or at a set interval in some examples, to identify critical inventory items for inventory optimization recommendations and/or critical inventory reports.

Data store 206 may be implemented within optimization environment 200, as depicted in the illustrative example of FIG. 2, or alternatively may be located remote from and communicatively coupled to optimization environment 200 (not shown). Inventory optimization component 202 and elasticity estimation component 204 may access data store 206 to obtain plurality of inventor data 208.

Inventory data 210 is an illustrative example of one set of inventory data associated with a specific entity for a given time period. Inventory data 210 may include entity data 212 and item data 214, as well as any other suitable information associated with inventory of an entity, such as a time period associated with the information. Entity data 212 may include an entity identifier, such as a store number within a chain of stores for example, and other entity-specific information associated with the identified entity, such as entity size, entity format, entity location, and so forth. Item data 214 may include information about a plurality of items associated with the current inventory of the entity identified in entity data 212. For example, item data may include information for a plurality of individual items, including assigned departments within the entity environment, assigned categories within the entity environment, item identifiers, item descriptions, item values, transaction values associated with the items, current inventory values on shelf, current inventory values off shelf, and the like. Item data 214 may also include variance date codes 216, which may include individual variance date codes associated with individual items. A variance date code refers to a shelf life associated with an item. In some examples, shelf life refers to a number of days an item may remain available for transaction before the item is to be discarded or removed from the shelf. Shelf life does not necessarily correspond to expiration dates, but may be used for some items to determine a time period the items may remain available before the inventory is to be reduced as a whole.

Inventory optimization component 202 may process inventory data 210 to identify critical inventory items. A critical inventory item is an item associated with a specific entity that has corresponding inventory data indicating an inventory overage for that item at that specific entity, or an entity-item overage indication. Inventory optimization component 202 may identify critical inventory items based on inventory data, including variance date codes, based on inventory-on-hand numbers and corresponding shelf life of the item, for example.

Inventory optimization component 202 may also use entity data 212 of inventory data 210 to determine one or more entity-specific factors 220 to use in normalizing item data 214, to generate normalized item data 222. Optionally, inventory optimization component 202 may determine one or more market factors 224 using market data 226, and may include market factors 224 and entity-specific factors 220 when processing inventory data 210 to generate normalized item data 222 and identify critical inventory item 228.

Elasticity estimation component 204 obtains or receives critical inventory item 222 from inventory optimization component 202, and obtains a portion of inventory data 223 corresponding to critical inventory item 228. Portion of inventory data 223 may be inventory data identified as associated with the same item identified in critical inventory item 228 but corresponding to entities other than the entity associated with critical inventory item 228. In other words, portion of inventory data 223 may be corresponding inventory data for the same item across a cluster of entities other than the identified entity. In some examples, elasticity estimation component 204 may determine entity-clusters based on computing similarities between a plurality of entities, and use entity-cluster inventory data corresponding to the identified item to determine a value response curve for the critical inventory item. In this way, the elasticity value determined for the critical inventory item is entity-cluster specific.

When calculating the elasticity for an individual critical inventory item, elasticity estimation component 204 identifiers a cluster of entities, or an entity cluster, based on inventory data associated with individual entities for a given time period. For example, a plurality of stores may be clustered based on item values for a given item at the individual entities and associated with a given week, or clustered based on geographical location of entities, or any other entity data. A sum of normalized quantity and average value may be calculated across a given period of time for a particular item. Elasticity estimation component 204 may then perform percentile capping and logging of the data for regression, including calculating the lower bound and upper bound percentile values of quantities sold for a specific item, choosing the lower bound and upper bound inflection points by selecting the percentile values that increased by a given percentage (i.e. increased by 10% or more), for an item where quantity sold for the given time period is more than the upper bound inflection point or less than the lower bound inflection point discarding that data from the regression calculation, and calculating the log of value and log of quantity to be used for the regression exercise. Elasticity estimation component 204 runs the log-log regression model to calculate beta coefficient/elasticity. In one exemplary illustration, the following equation may be used:

$$Log ( quantity ) = Log ( value ) by \frac{item}{value} cluster$$

Elasticity estimation component 204 may run portion of inventory data 223 against a number of models to determine value response curve 230 for critical inventory item 228. Elasticity estimation component 204 may run the normalized inventory data associated with the critical inventory item against the number of models to determine a number of data points for the associated data, and based on the number of data points determines which one or more of the models is/are the best fit for the critical inventory item. The models used by elasticity estimation component 204 may include, without limitation, a linear model, a log linear model, a power model, a logit model, or any other suitable model. Each model may have an associated data point threshold, which may be a minimum number of data points that are to be present in the data in order for the model to be a fit, or optimal fit, for the data. For example, a linear model may have a minimum threshold of three data points, a log linear model may have a minimum threshold of four data points, a power model may have a minimum threshold of five data points, and a logit model may have a minimum threshold of five data points. In this example, if elasticity estimation component 204 processes normalized data corresponding to a critical inventory item, and determines the number of data points is four, the data may be run against both the linear and the log linear models, because the minimum threshold is satisfied for both of these models, but may not be run against the power and logit models because the minimum threshold is not satisfied. In another example, where more than five data points are identified, all four models may be run against the data. In yet another example, if a determination is made that three data points are available, the linear model may be used to determine the value response curve.

In some example, where more than one model may be available at any level, a choice of model is made by model selection component 232 based on R square values, selecting a model returning a higher R square value, signifying a best fit. Elasticity estimation component 204 may then use the value response curve suggested by the value response curve selection component.

Elasticity estimation component 204 uses value response curve 230 to calculate entity-cluster elasticity measure 234 for critical inventory item 228. Entity-cluster elasticity measure 234 is specific to an identified cluster of entities associated with critical inventory item 228. Inventory optimization component 202 obtains or receives entity-cluster elasticity value 234 for critical inventory item 228, and uses entity-cluster elasticity value 234 to generate inventory optimization recommendation 236.

Inventory optimization recommendation 236 may include one or more inventory opportunities for selection, such as a value adjustment recommendation (i.e. markdown or reduction), item feature recommendation, and/or inventory adjustment recommendation. For example, inventory optimization recommendation 236 may indicate the current value of the item at that entity and a suggested new value for the item at that entity. Inventory optimization recommendations may be subject to conditions, or tied to parameters, in some examples. For example, a value adjustment recommendation may include parameters such as, without limitation, a time period associated with the adjustment (i.e. adjusted value set to expire after two weeks from implementation), candidate item not associated with a previous critical inventory report within a given time period, entity department valuation rules (i.e. designated price point endings, no value adjustments for less than a given increment, etc.), threshold for a number of value adjustments in a given time period (i.e. no more than five markdowns per store per week), value adjustment within item cost parameters, or any other suitable parameter.

Inventory optimization component 202 may aggregate individual inventory optimization recommendations associated with a specific entity into a critical inventory report for that entity. Critical inventory report 238 may include a plurality of inventory optimization recommendation for a specific, individual entity, with each individual recommendation associated with an individual item. Inventory optimization component 202 may output critical inventory report 238 to a user interface associated with an inventory system of the entity, or otherwise transmit the report to the entity. Optimization environment 200 may store critical inventory reports in report database 240, where reports may be accessed or obtained for aggregation across a cluster of entities or for an entity environment, for example. As new data is available, including new inventory data, market data, or other entity-related data, inventory optimization component 202 may process the new data as described above to generate updated or dynamic inventory optimization recommendations. In this way, examples of the disclosure may provide dynamic inventory optimization recommendations using the most recent data available to provide optimal item valuations for a specific entity.

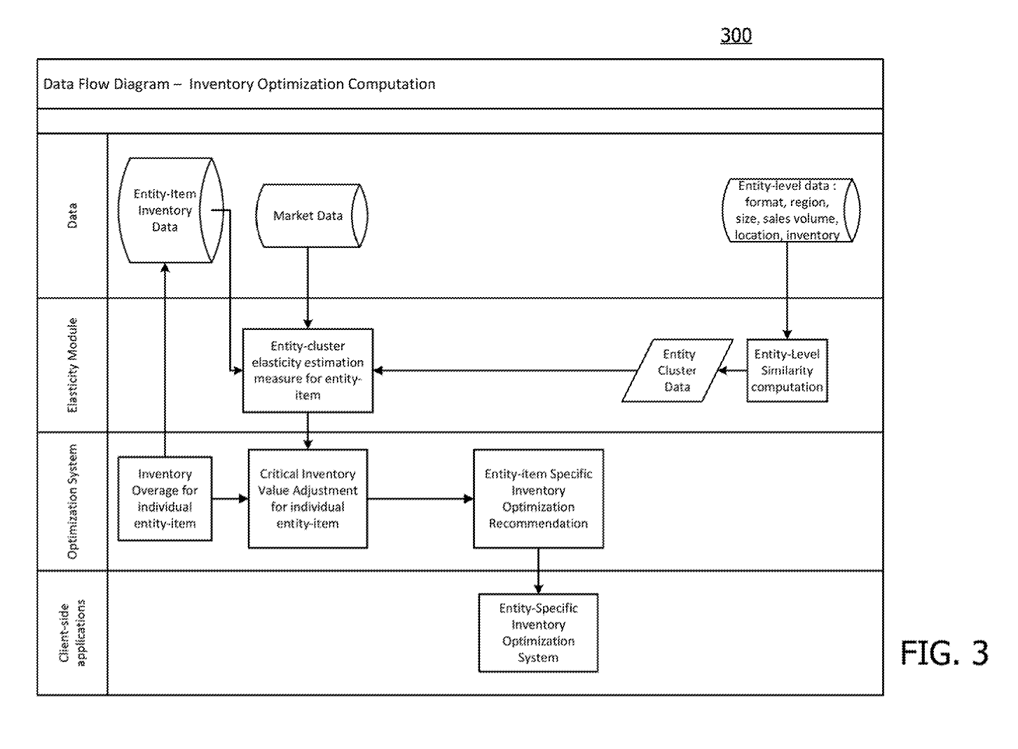

FIG. 3 is an exemplary flow diagram illustrating network communication between components and data flow within an optimization environment for entity-specific inventory optimization. Optimization environment 300 may be an illustrative example of one implementation of optimization environment 108 in FIG. 1 and/or optimization environment 200 in FIG. 2.

As depicted in this illustrative data flow, entity-item inventory data for an individual item associated with an individual entity, such as current inventory volume, historical transaction volume, valuation, transaction information, time, seasonality, and so forth, may be available in a database for processing along with market data as part of generating an entity-cluster elasticity estimation measure for that item. The elasticity module may calculate entity cluster data using entity-level data, such as entity format, region, size, sales volume, location, inventory, and so forth, to cluster entities using entity-level similarity computations and provide entity-cluster data. The entity-cluster elasticity estimation for an entity-item (a specific item corresponding to a specific entity) is used along with inventory overage data for the individual entity-item to identify critical inventory value adjustments for individual entity-items and generate an entity-item specific inventory optimization recommendation for output to an entity-specific inventory optimization system. The entity-specific inventory optimization system may be a client-side application in some examples.

Optionally, entity-item specific value adjustments may be output to an automated markdown management system for automatic valuation adjustments at a client-side application, for example.

FIG. 4 is an exemplary flow chart illustrating operation of the computing device to generate an inventory optimization recommendation for an individual item relative to an individual entity. The exemplary operations presented in FIG. 4 may be performed by one or more components described in FIG. 1 or FIG. 2, for example.

The process obtains inventory data for an individual entity at operation 402. The inventory data may include a plurality of item data associated with the individual entity, for example. The process determines whether at least one item of the included item data for the obtained inventory data exceeds an inventory threshold at operation 404. The inventory threshold may be specific to the item, specific to the entity, or both specific to the item and entity, for example. Inventory thresholds may be set for individual items at an individual entity level, in some examples, and accessed by the inventory optimization system when determining whether at least one item exceeds an inventory threshold.

The process calculates an elasticity value for the at least one item at operation 406. The item identified as exceeding an inventory threshold may be considered a critical inventory item. The elasticity value may be calculated by the elasticity estimation module by identifying a value response curve for the item, in some examples. The value response curve for the critical inventory item may be determined based at least in part on entity-cluster data corresponding to the critical inventory item. Inventory data associated with a determined entity-cluster may be obtained and normalized for use in calculating the value response curve. Normalizing the data does not refer to the structure of the data, but rather adjusting the data itself based on variable weights of various entity-specific factors.

The process generates an entity-cluster elasticity value for the at least one item based on the value response curve at operation 408. The normalized data may be processed to identify a number of data points, and the number of data points drives the selection of one or more models to run that normalized data against, based on minimum data point thresholds of the various models. The process generates an entity-specific inventory optimization recommendation for the critical inventory item based on the entity-cluster elasticity value at operation 410, based on the identified value response curve. The process generates a critical inventory report for the specific entity associated with the critical inventory item at operation 412. The critical inventory report includes the generated entity-specific inventory optimization recommendation for the critical inventory item and may include any other inventory optimization recommendations associated with the same specific entity corresponding to other identified critical inventory items for the given time period, for example. The process outputs the critical inventory report to a user interface at operation 414, with the process terminating thereafter.

FIG. 5 is an exemplary flow chart illustrating operation of the computing device to generate adjustments across an entity cluster. The exemplary operations presented in FIG. 5 may be performed by one or more components described in FIG. 1 or FIG. 2, for example. In some examples, a home office managing a plurality of entities may use this exemplary process to generate an adjustment across a cluster of entities or company-wide.

The process identifies a plurality of critical inventory reports for a given time period at operation 502. The plurality of critical inventory reports may be one or more individual reports corresponding to one or more individual entities, for example. In one exemplary scenario, a selection of a given time period may be received and corresponding critical inventory reports returned for that given time period. The corresponding critical inventory reports may identify critical inventory items for that given time period across a plurality of entities, providing insight into a broader critical inventory issue, for example. This provides for an opportunity to correct inventory forecasts for an item across an entity group and/or chain, perform inventory audits across an entity group and/or chain, or submit entity group and/or chain-level adjustments for the impacted item or group of entities, for example. This also provides an aggregate view of inventory information across an entity group, which further allows for insight into how a particular item may be impacting the entity group.

The process receives a selection of an item for adjustment at operation 504. The selection may be for a specific critical inventory item identified in one or more of the plurality of critical inventory reports. Note that the selection of an item refers to the inventory of that item at the associated entities. In other words, the selection of an individual item, as used herein, is not a selection of an individual saleable unit, but rather the total inventory for the selected item at the associated or selected entities. This provides for total item inventory adjustment at the associated entities or entity groups.

The process generates a list of one or more entities associated with the selected item at operation 506. The entities associated with the selected item may be any entity having the selected item indicated as a critical inventory item on a critical inventory report for the selected time period, for example. The process determines whether a value adjustment is received for the selected item at operation 508. If a determination is made that the value adjustment is received for the selected item, the process transmits the received value adjustment to the one or more entities of the generated list at operation 510.

If a determination is made that a value adjustment is not received, the process determines whether a forecast adjustment is received for the selected item at operation 512. A forecast adjustment may refer to an adjustment of an inventory replenishment value for the selected item and the identified one or more entities, for example. If the process determines that the forecast adjustment is received, the process transmits the received forecast adjustment to a replenishment system associated with the one or more entities of the generated list, and terminates thereafter. If a determination is made that the value adjustment is not received and the forecast adjustment is not received, the process terminates.

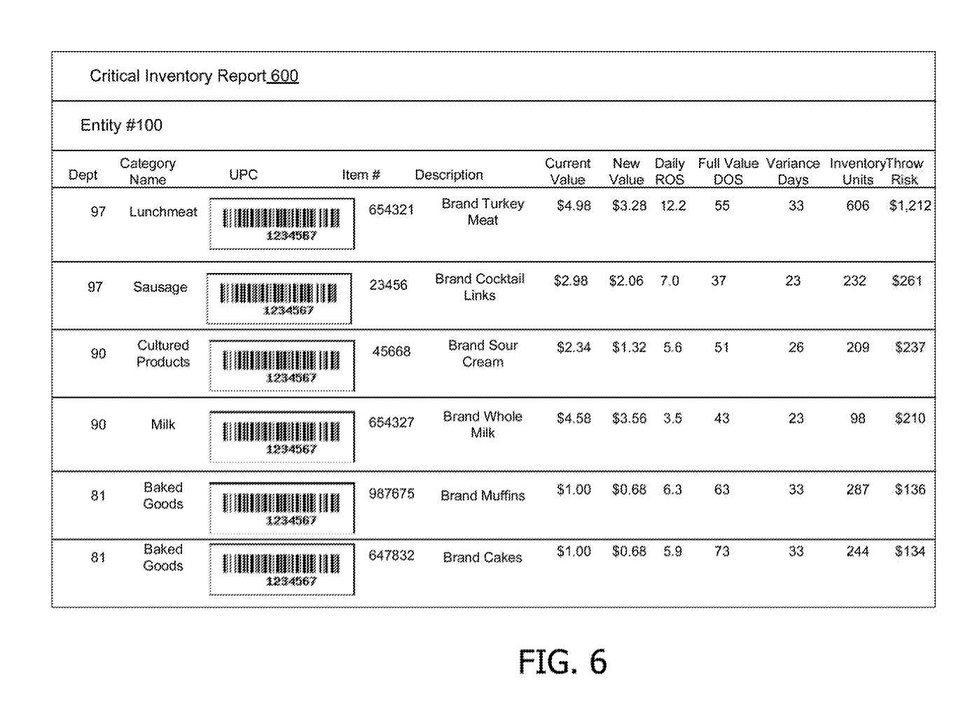

FIG. 6 is an exemplary diagram illustrating a critical inventory report. Critical inventory report 600 is an illustrative example of one implementation of critical inventory report 238 in FIG. 2.

Critical inventory report 600 includes an entity identifier and inventory value adjustment recommendations for a number of critical inventory items. In this exemplary diagram, individual inventory items are identified by department, category, item number, and description, providing a current value and a suggested new value for markdown of the item. A universal product code (UPC) may optionally be provided in the report to allow for an efficient value update—or markdown—of any selected items off the report. Other information in this example report includes a daily rate of sale (ROS) for an individual item, as well as days on shelf (DOS) value for the item when at full value, variance date code information, a number of inventory units on hand, and a calculated throw risk associated with the item at the current value. The information in critical inventory report 600 is provided for illustrative purposes only, and does not limit aspects of this disclosure in any way. Other data may be included in a critical inventory report, in any suitable configuration.

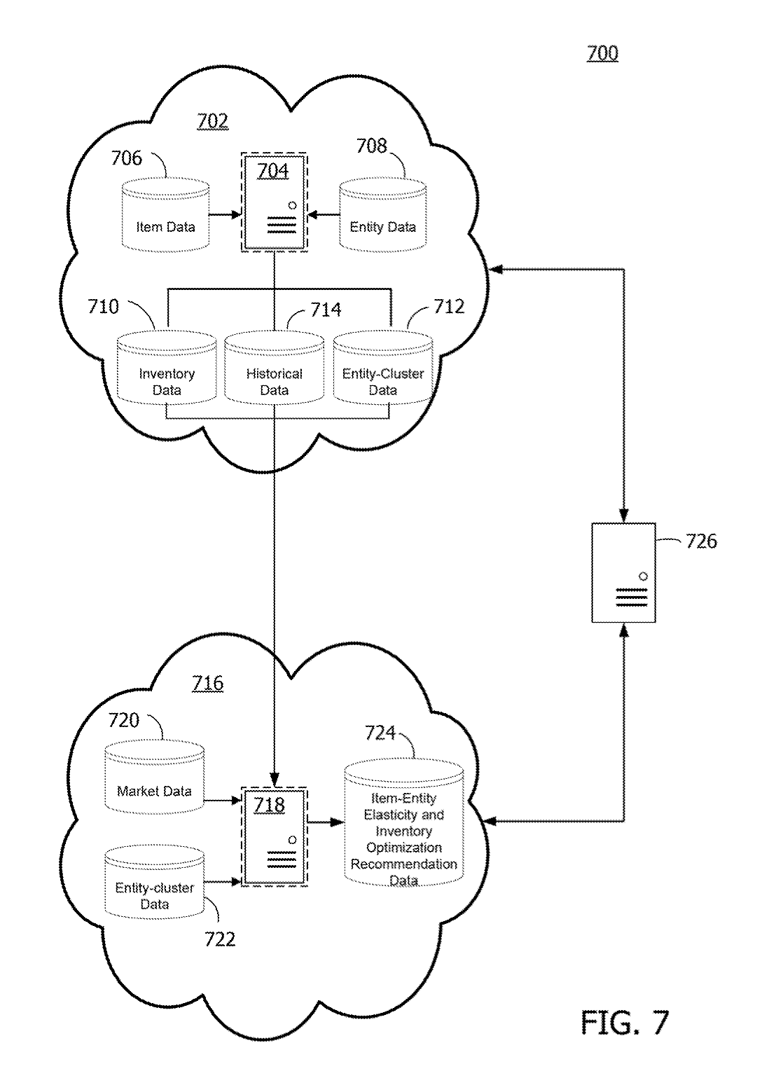

FIG. 7 is an exemplary diagram illustrating an optimization environment operating as a cloud-based service. Optimization environment 700 may be an illustrative example of optimization environment 108 in FIG. 1 and/or optimization environment 200 in FIG. 2.

Optimization environment 700 may be implemented in a cloud-based environment, with one or more operations performed in the cloud, for example. In this illustrative example, cloud location 702 may include virtual server 704, which may process item data 706 and entity data 708 to generate inventory data 710, entity-cluster data 712, and historical data 714.

Cloud location 716 may be communicatively coupled to cloud location 702, via a communication network, or other network, to receive and/or obtain cluster data, item data, and entity data. Virtual server 718 may provide optimization operations, such as those depicted in FIG. 4 and FIG. 5. for example, to process the data pertaining to individual items and individual entities, or clusters thereof, to generate elasticity estimations and inventory optimization recommendations. Market data 720 may be used in conjunction with entity-cluster data 722 to generate item-entity elasticity and inventory optimization recommendation data 724, which may be output to a client-side value optimization system residing on a client-side server, such as server 726 in this illustrative example.

### ADDITIONAL EXAMPLES

In some examples, elasticity is tied to entity-specific inventory data and item-specific variance date code data to determine what an optimal value or price may be for a specific item at a specific location, in order to reduce inventory at a rate that maximizes revenue and minimizes throw risk or waste. In some instances, a company-wide adjustment may be made when aggregate critical inventory reports for individual entities identify a commonality between inventory overages across entities and a specific item, for example. This provides a highly customized inventory optimization solution for individual entities or store locations, as well as a company of stores, to variably adjust valuations, inventory, and forecasts across different store locations in order to maximize revenue and reduce waste across the company.

As one illustrative example, a number of entities within a company may have the same item type appear as an inventory optimization opportunity on their individual entity-specific critical inventory reports. For example, 800 stores may have Brand X Juice appear on their critical inventory reports as an opportunity, which may in turn group those 800 stores at the company or corporate level based on that similarity in reports, such that a buyer at the corporate level may identify the Brand X Juice as an item that may benefit from batch inventory adjustment at least at the group of stores, while other stores within the company may not need inventory adjustment. The individual entities may be treated as unique entities with unique recommendations for inventory optimization based on a current demand and inventory levels associated with that unique entity, or alternatively a company may cluster or group multiple entities with similar inventory opportunities together and aggregate a recommendation for the group of stores, in some examples.

Alternatively, or in addition to the other examples described herein, examples include any combination of the following:

dynamically adjusts the identified value response curve for the identified at least one item as new inventory data corresponding to the at least one item and the individual entity is received;

generates an adjusted value optimization recommendation based on the dynamic adjustment;

wherein the elasticity estimation module is further configured to identify the value response curve for the identified at least one item associated with the individual entity based on at least one of a linear, log linear, power, or logit model;

wherein the elasticity estimation module is further configured to identify the value response curve for the identified at least one item associated with the individual entity using entity-cluster data;

wherein the entity-cluster data includes a plurality of entity data aggregated based at least in part on entity attributes;

wherein the inventory optimization recommendation includes at least one of a value adjustment recommendation, an item feature recommendation, or an inventory adjustment recommendation;

wherein the inventory optimization recommendation associated with the at least one item is provided as part of an entity-specific inventory report;

wherein the inventory optimization module further processes the entity-specific inventory report to determine inventory replenishment values for the at least one item for a future time period based on the inventory data at the given time;

wherein the individual entity is a specific retail store location;

dynamically adjusting the identified value response curve for the identified at least one item as new inventory data corresponding to the at least one item and the individual entity is received;

generating an adjusted value optimization recommendation based on the dynamic adjustment;

wherein identifying the value response curve for the identified at least one item associated with the individual entity is based on at least one of a linear, log linear, power, or logit model;

wherein identifying the value response curve for the identified at least one item associated with the individual entity includes using entity-cluster data;

wherein the entity-cluster data includes a plurality of entity data aggregated based at least in part on entity attributes;

wherein the inventory optimization recommendation includes at least one of a value adjustment recommendation, an item feature recommendation, or an inventory adjustment recommendation;

wherein the forecast adjustment impacts a supply chain for the at least one item and the individual entity to adjust inventory replenishment values at the individual entity;

wherein the elasticity estimation module is further configured to identify the value response curve for the identified at least one item associated with the individual entity using entity-cluster data;

wherein the inventory optimization component obtains other inventory data for other individual entities, aggregates the other inventory data from the other individual entities to identify at least one other item exceeding the inventory threshold across the other individual entities, generates another critical inventory report for the other individual entities, receives other data input in response to the other critical inventory report, and transmits the other data input to the other individual entities to adjust at least one of a value or a forecast associated with the at least one other item across the other individual entities;

wherein the critical inventory report includes an identification of individual item-entity combinations exceeding the inventory threshold based on a number of variance codes.

In some examples, the operations illustrated in FIG. 4 and FIG. 5 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

### Exemplary Operating Environment

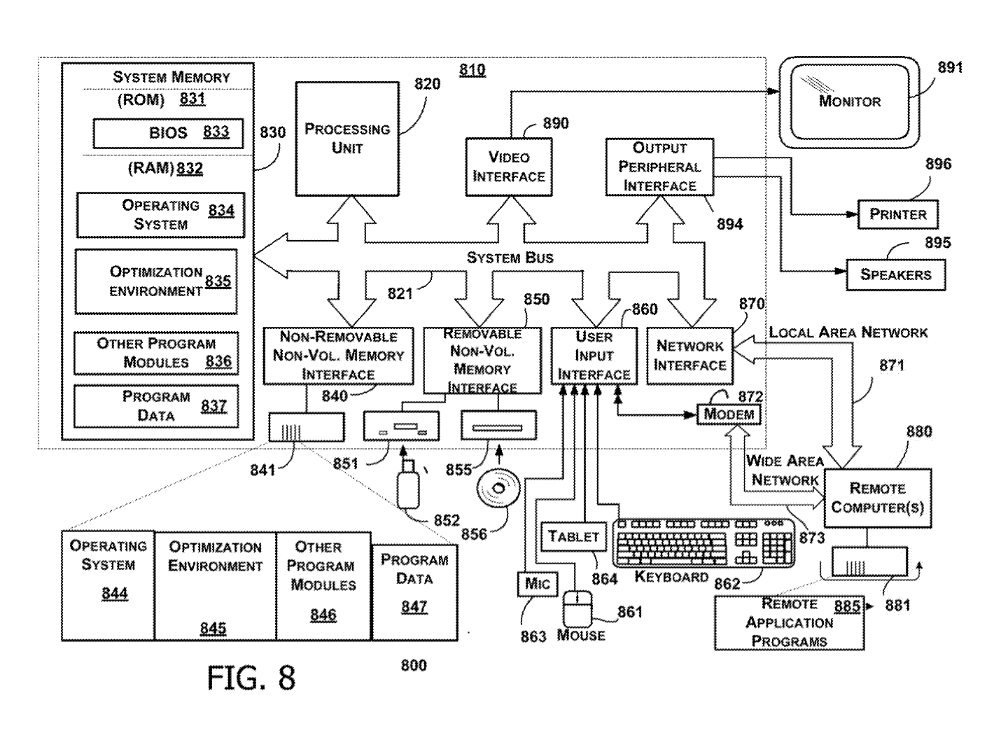

FIG. 8 illustrates an example of a suitable computing and networking environment 800 on which the examples of FIG. 1 may be implemented. The computing system environment 800 is only one example of a suitable computing environment and is not intended to suggest any limitation as to the scope of use or functionality of the disclosure. Neither should the computing environment 800 be interpreted as having any dependency or requirement relating to any one or combination of components illustrated in the exemplary operating environment 800.

The disclosure is operational with numerous other general purpose or special purpose computing system environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 8, an exemplary system for implementing various aspects of the disclosure may include a general purpose computing device in the form of a computer 810. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media may be any available media that may be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Memory 831 and 832 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computer 810. Computer storage media does not, however, include propagated signals. Rather, computer storage media excludes propagated signals. Any such computer storage media may be part of computer 810.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs, such as optimization environment 835, other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a universal serial bus (USB) port 851 that provides for reads from or writes to a removable, nonvolatile memory 852, and an optical disk drive 855 that reads from or writes to a removable, nonvolatile optical disk 856 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and USB port 851 and optical disk drive 855 are typically connected to the system bus 821 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 844, optimization environment 845, other program modules 846 and program data 847. Note that these components may either be the same as or different from operating system 834, optimization environment 835, other program modules 836, and program data 837. Operating system 844, optimization environment 845, other program modules 846, and program data 847 are given different numbers herein to illustrate that, at a minimum, they are different copies. A user may enter commands and information into the computer 810 through input devices such as a tablet, or electronic digitizer, 864, a microphone 863, a keyboard 862 and pointing device 861, commonly referred to as mouse, trackball or touch pad. Other input devices not shown in FIG. 8 may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. The monitor 891 may also be integrated with a touch-screen panel or the like. Note that the monitor and/or touch screen panel may be physically coupled to a housing in which the computing device 810 is incorporated, such as in a tablet-type personal computer. In addition, computers such as the computing device 810 may also include other peripheral output devices such as speakers 895 and printer 896, which may be connected through an output peripheral interface 894 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 871 and one or more wide area networks (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860 or other appropriate mechanism. A wireless networking component such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are exemplary and other means of establishing a communications link between the computers may be used.

The examples illustrated and described herein as well as examples not specifically described herein but within the scope of aspects of the disclosure constitute an exemplary entity-specific inventory optimization environment. For example, the elements illustrated in FIG. 1 and FIG. 2, such as when encoded to perform the operations illustrated in FIG. 4 and FIG. 5, constitute exemplary means for obtaining inventory data for an individual entity, exemplary means for identifying a critical inventory item, and exemplary means for generating an inventory optimization recommendation for the identified critical inventory item.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for inventory optimization, the system comprising:
an interface coupled to a communication network;
at least one processor coupled to the interface via the communication network;
an inventory optimization module, implemented on the at least one processor, that:
obtains inventory data for an individual entity at a given time, the inventory data including variance date codes associated with individual items; and
identifies at least one item of a plurality of items exceeding an inventory threshold based on the inventory data; and
an elasticity estimation module, implemented on the at least one processor, that:
receives the identified at least one item from the inventory optimization module;
calculates an elasticity value for the identified at least one item based at least in part on entity-cluster data; and
generates an entity-specific elasticity value for the identified at least one item, the inventory optimization module further generating an inventory optimization recommendation based on the generated entity-specific elasticity value and the variance date codes of the inventory data.

2. The system of claim 1, wherein the inventory optimization module further:
dynamically adjusts the identified value response curve for the identified at least one item as new inventory data corresponding to the at least one item and the individual entity is received; and
generates an adjusted value optimization recommendation based on the dynamic adjustment.

3. The system of claim 1, wherein the elasticity estimation module calculates the elasticity value for the identified at least one item, including by identifying a value response curve for the identified at least one item associated with the individual entity based on at least one of a linear, log linear, power, or logit model.

4. The system of claim 1, wherein the entity-cluster data includes a plurality of entity data aggregated based at least in part on entity attributes.

5. The system of claim 1, wherein the inventory optimization module identifies the at least one item exceeding the inventory threshold based at least in part upon calculating the variance date codes against current inventory levels for the individual entity at the given time.

6. The system of claim 1, wherein the inventory optimization recommendation includes at least one of a value adjustment recommendation, an item feature recommendation, an inventory adjustment recommendation, or a no action recommendation.

7. The system of claim 6, wherein the inventory optimization recommendation associated with the at least one item is provided as part of an entity-specific inventory report.

8. The system of claim 7, wherein the inventory optimization module further processes the entity-specific inventory report to determine inventory replenishment values for the at least one item for a future time period based on the inventory data at the given time.

9. The system of claim 1, wherein the individual entity is a specific retail store location.

10. A method for inventory optimization implemented at least in part on at least one processor, comprising:
obtaining inventory data for an individual entity at a given time, the inventory data including variance date codes associated with individual items;
identifying at least one item of a plurality of items exceeding an inventory threshold based on the inventory data;
receiving the identified at least one item from the inventory optimization module;
identifying a value response curve for the identified at least one item based at least in part on an entity-cluster elasticity measure; and
generating an item-specific elasticity value for the identified at least one item based on the identified value response curve, the inventory optimization module further generating an entity-specific inventory optimization recommendation based on the generated item-specific elasticity value and the variance date codes of the inventory data.

11. The method of claim 10, further comprising:
dynamically adjusting the identified value response curve for the identified at least one item as new inventory data corresponding to the at least one item and the individual entity is received; and
generating an adjusted value optimization recommendation based on the dynamic adjustment.

12. The method of claim 10, wherein identifying the value response curve for the identified at least one item associated with the individual entity is based on at least one of a linear, log linear, power, or logit model.

13. The method of claim 10, wherein identifying the value response curve for the identified at least one item associated with the individual entity includes using entity-cluster data.

14. The method of claim 13, wherein the entity-cluster data includes a plurality of entity data aggregated based at least in part on entity attributes.

15. The method of claim 10, wherein the inventory optimization recommendation includes at least one of a value adjustment recommendation, an item feature recommendation, or an inventory adjustment recommendation.

16. One or more computer storage devices having computer-executable instructions stored thereon for inventory optimization, which, on execution by a computer, cause the computer to perform operations comprising:
an inventory optimization component that obtains inventory data for an individual entity at a given time and identifies at least one item of a plurality of items exceeding an inventory threshold based on the inventory data, the inventory data including variance date codes associated with individual items;
an elasticity estimation component that identifies a value response curve for the identified at least one item and generates an entity-specific elasticity value for the identified at least one item;
the inventory optimization component further generating a critical inventory report for the individual entity based on the generated entity-specific elasticity value and the variance date codes of the inventory data, receiving data input in response to the generated critical inventory report, the data input comprising at least one of a value adjustment or a forecast adjustment associated with the at least one item and the individual entity, and transmitting the data input to an inventory system of the individual entity.

17. The one or more computer storage devices of claim 16, wherein the forecast adjustment impacts a supply chain for the at least one item and the individual entity to adjust inventory replenishment values at the individual entity.

18. The one or more computer storage devices of claim 16, wherein the elasticity estimation module is further configured to identify the value response curve for the identified at least one item associated with the individual entity using entity-cluster data.

19. The one or more computer storage devices of claim 16, wherein the inventory optimization component obtains other inventory data for other individual entities, aggregates the other inventory data from the other individual entities to identify at least one other item exceeding the inventory threshold across the other individual entities, generates another critical inventory report for the other individual entities, receives other data input in response to the other critical inventory report, and transmits the other data input to the other individual entities to adjust at least one of a value or a forecast associated with the at least one other item across the other individual entities.

20. The one or more computer storage devices of claim 16, wherein the critical inventory report includes an identification of individual item-entity combinations exceeding the inventory threshold based on a number of variance codes.
